(19) United States
(12) Patent Application Publication
(10) Pub. No.: US 2014/0015228 A1
(43) Pub. Date: Jan. 16, 2014

(54) STROLLER

(71) Applicant: COMBI CORPORATION, TOKYO-TO (JP)

(72) Inventor: TOSHIHIRO KIKUI, TOKYO-TO (JP)

(73) Assignee: COMBI CORPORATION, TOKYO-TO (JP)

(21) Appl. No.: 13/712,466

(22) Filed: Dec. 12, 2012

(30) Foreign Application Priority Data
Jul. 10, 2012 (JP) 2012-154831

(51) Int. Cl. B62B 7/08; B62B 7/00

(52) U.S. Cl. CPC B62B 7/08; B62B 7/008
USPC 280/650; 280/47.38

(57) ABSTRACT

A stroller (10) includes: a front leg (31); a middle leg (34) located rearward of the front leg; a rear leg (37) located rearward of the middle leg; a front-wheel holding mechanism (21) provided on the front leg; a middle-wheel holding mechanism (24) provided on the middle leg; and a rear-wheel holding mechanism (27) provided on the rear leg. The front-wheel holding mechanism is configured to rotatably and turnably hold a front wheel (22). The middle-wheel holding mechanism is configured to rotatably and unturnably hold a middle wheel (25). The rear-wheel holding mechanism is configured to rotatably and turnably hold a rear wheel (28).

### CROSS REFERENCE TO RELATED APPLICATIONS

This application is based upon and claims the benefit of priority from the prior Japanese Patent Application No. 2012-154831 filed on Jul. 10, 2012, the entire contents of which are incorporated herein by reference.

### BACKGROUND OF THE INVENTION

1. Field of the Invention

The present invention relates to a stroller capable of letting babies ride thereon in such a manner that the babies are seated in a back and front direction.

2. Background Art

As disclosed in US2002-033588, strollers capable of transporting a plurality of babies are used. As such strollers, there are known strollers of the type in which babies are seated in the lateral direction, and a stroller of a type in which babies are seated in the back and front positions. In the stroller of either type, a caregiver of the babies steers the stroller from a rear side thereof, while grasping a handle disposed on a rear part of the stroller. Generally, when the stroller travels along a curved path, the stroller is turned about an axis of a rear wheel position in the back and front direction, so as to change a traveling direction (facing direction) of the stroller.

However, in the stroller of a type in which babies are seated in the back and front position, i.e., in the tandem-type stroller, an overall length from the back to the front is longer. Thus, in the stroller of a type in which babies are seated in tandem, the center of gravity of the stroller transporting the babies is positioned largely forward of a turning center of the stroller about which the stroller is turned to change its traveling direction. On the other hand, the handle to which a force is applied by the steering person is positioned near to the turning center of the stroller about which the stroller is turned so as to change its traveling direction, in the back and front direction. Thus, when the stroller is turned, it is necessary for the steering person to apply a very large force to the handle, which makes the steering difficult.

### BRIEF SUMMARY OF THE INVENTION

The present invention has been made in view of the above circumstances. The object of the present invention is to improve the steerability of a stroller.

A first stroller according to the present invention is a stroller including:
a front leg;
a middle leg located rearward of the front leg;
a rear leg located rearward of the middle leg;
a front-wheel holding mechanism provided on the front leg, the front-wheel holding mechanism being configured to rotatably and turnably hold a front wheel;
a middle-wheel holding mechanism provided on the middle leg, the middle-wheel holding mechanism being configured to rotatably and unturnably hold a middle wheel; and
a rear-wheel holding mechanism provided on the rear leg, the rear-wheel holding mechanism being configured to rotatably and turnably hold a rear wheel,
wherein the stroller is capable of letting babies ride thereon in such a manner that the babies are seated in a back to front position.

The first stroller stroller according to the present invention may further include:
a handle;
a first link element pivotably joined, at a rear portion thereof, to the handle, and pivotably joined, at a front portion thereof, to the front leg;
a second link element pivotably joined to a front portion of a fourth link element, and pivotably joined to an intermediate portion of the first link element;
a third link element pivotably joined, at a rear portion thereof, to the second link element, and pivotably joined to an upper portion of the front leg and an upper portion of the middle leg;
the fourth link element pivotably joined, at a rear portion thereof, to the handle, and pivotably joined to an upper portion of the rear leg;
a fifth link element pivotably joined to the second link element and the middle leg, respectively; and
a sixth link element pivotably joined to the handle and the rear leg, respectively.

In the first stroller according to the present invention, a pair of the front legs may be provided to be spaced apart from each other in a width direction; a pair of the middle legs may be provided to be spaced apart from each other in the width direction; a pair of the rear legs may be provided to be spaced apart from each other in the width direction; the front-wheel holding mechanism may be provided on each front leg; the middle-wheel holding mechanism may be provided on each middle leg; and the rear-wheel holding mechanism may be provided on each rear leg.

In the first stroller according to the present invention, the front leg may include a pair of extending parts located to be spaced apart from each other in a width direction, and a connection part connecting the pair of extending parts; a pair of the middle legs may be provided to be spaced apart from each other in the width direction; a pair of the rear legs may be provided to be spaced apart from each other in the width direction; the front-wheel holding mechanism may be provided on the connection part; the middle-wheel holding mechanism may be provided on each middle leg; and the rear-wheel holding mechanism may be provided on each rear leg.

A second stroller according to the present invention is a stroller including:
a front leg;
a rear leg located rearward of the front leg;
a middle leg located rearward of the middle leg;
a first link element pivotably joined, at a front portion thereof, to the front leg;
a handle pivotably joined to a rear portion of the first link element;
a second link element pivotably joined to a front portion of a fourth link element, and pivotably joined to an intermediate portion of the first link element;
a second link element pivotably joined to a front portion of the fourth link element, and pivotably joined to an intermediate portion of the first link element;
a third link element pivotably joined, at a rear portion thereof, to the second link element, and pivotably joined to an upper portion of the front leg and an upper portion of the middle leg;
the fourth link element pivotably joined, at a rear portion thereof, to the handle, and pivotably joined to an upper portion of the rear leg;
a fifth link element pivotably joined to the second link element and the middle leg, respectively; and
a sixth link element pivotably joined to the handle and the rear leg, respectively.

In the second stroller according to the present invention, a pair of the front legs may be provided to be spaced apart from each other in a width direction; a pair of the middle legs may be provided to be spaced apart from each other in the width direction; and a pair of the rear legs may be provided to be spaced apart from each other in the width direction.

In the second stroller according to the present invention, the front leg may include a pair of extending parts located to be spaced apart from each other in a width direction, and a connection part connecting the pair of extending parts; a pair of the middle legs may be provided to be spaced apart from each other in the width direction; and a pair of the rear legs may be provided to be spaced apart from each other in the width direction.

The first or second stroller according to the present invention may further include a first seat unit for letting a baby ride thereon and a second seat unit for letting a baby ride thereon, wherein the second seat unit is supported by a position, of the first link element, located rearward of the position at which the first link element is joined to the second link element, and the first seat unit is supported by the first link element on a position that is forward of the second seat unit.

The first or second stroller according to the present invention may further include a first seat unit for letting a baby ride thereon and a second seat unit for letting a baby ride thereon, wherein the first seat unit is supported by the third link element, and the second seat unit is supported by the fourth link element.

The first or second stroller according to the present invention may further include a first seat unit for letting a baby ride thereon and a second seat unit for letting a baby ride thereon, wherein at least a portion of the first seat unit is located between the front leg and the middle leg, in the back and front direction of the stroller, and the second seat unit is located rearward of the first seat unit, and at least a portion of the second seat unit is located between the middle leg and the rear leg, in the back and front direction of the stroller.

According to the present invention, it is possible to improve the steerability of a stroller.

### BRIEF DESCRIPTION OF THE DRAWINGS

FIG. 1 is a perspective view of first embodiment of the present invention, showing, from a lateral side, a stroller in the unfolded condition.

FIG. 2 is a perspective view showing, from the lateral side, the stroller in FIG. 1 in the course of being folded.

FIG. 3 is a view showing, from the lateral side, the stroller in FIG. 1 in the folded condition.

FIG. 4 is a diagrammatic view schematically showing a structure of the stroller in FIG. 1.

FIG. 5 is a view corresponding to FIG. 4, showing a modification example of a seat unit.

FIG. 6 is a view illustrating the action of the stroller that is being turned.

FIG. 7 is a view for illustrating the action of a conventional stroller being turned.

FIG. 8 is a view corresponding to FIG. 1, showing a modified example of the stroller.

FIG. 9 is a view corresponding to FIG. 3, showing the stroller in FIG. 8 in the folded condition.

### DETAILED DESCRIPTION OF THE INVENTION

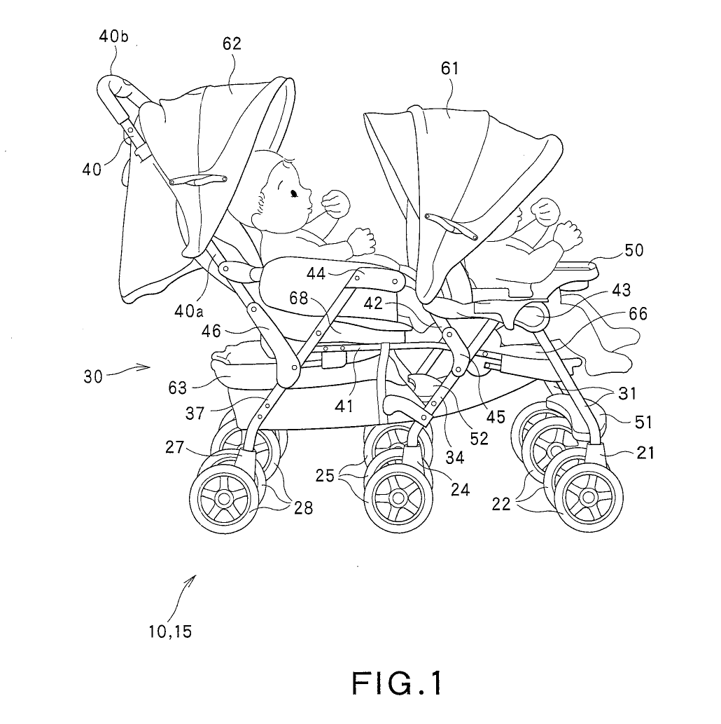

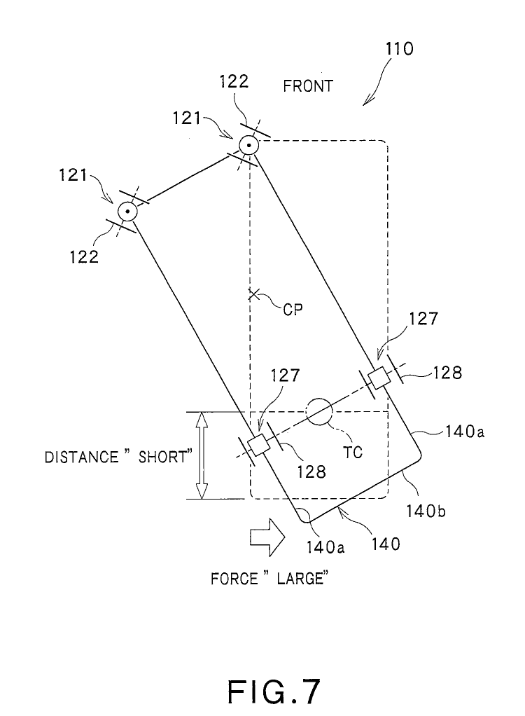

An embodiment of the present invention will be described herebelow with reference to the drawings. FIGS. 1 to 6 are views for explaining an embodiment of a stroller according to the present invention. FIG. 7 is prior art.

FIGS. 1 to 3 show a stroller 10 in one embodiment of the present invention. As shown in FIG. 1, the stroller 10 includes a stroller body 15, a first seat unit 66 supported by the stroller body 15, and a second seat unit 68 supported by the stroller body 15. The first seat unit 66 and the second seat unit 68 are places on which babies are seated, and are arranged to be aligned back to front. Namely, the illustrated stroller 10 is constituted as a two-seater stroller of a tandem type.

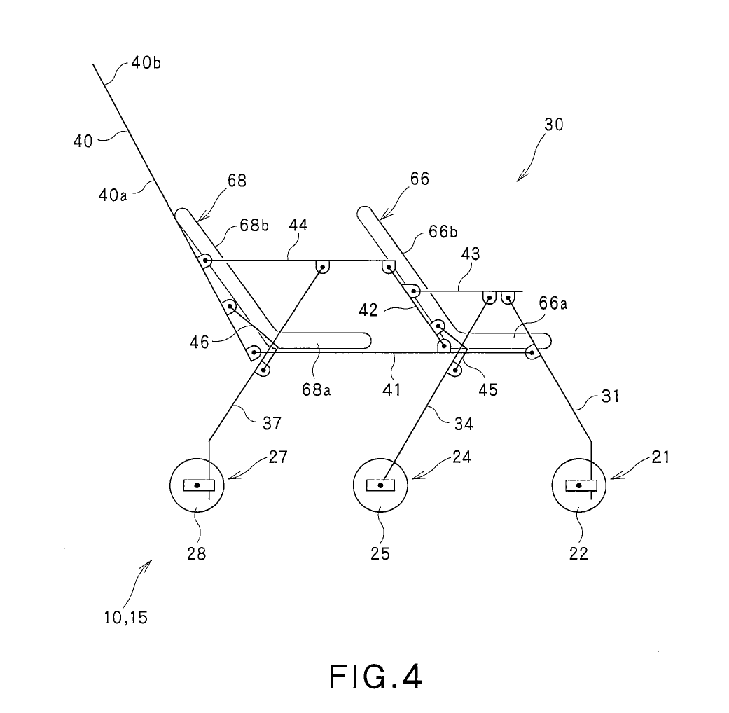

As is shown in FIG. 4, the stroller body 15 includes a frame part 30 having legs 31, 34 and 37 and a handle 40, and wheel holding mechanism 21, 24 and 27 provided on lower portions of the respective legs 31, 34 and 37.

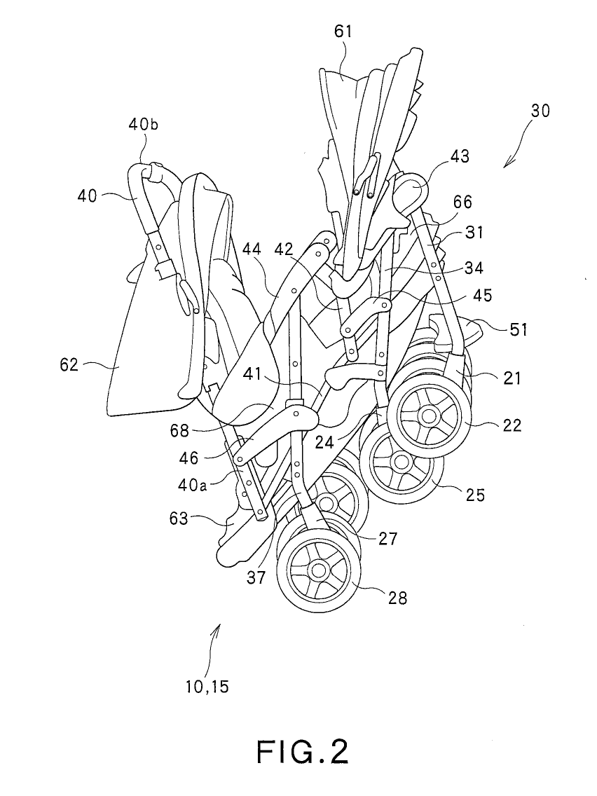

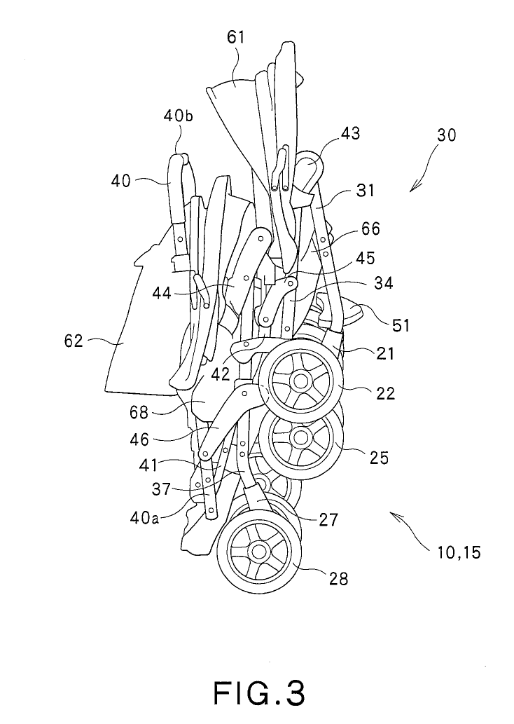

In addition, as shown in FIGS. 2 and 3, the illustrated stroller 10 can be folded such that the legs 31, 34 and 37 and the handle 40 are brought close to each other. Many constituent elements of the stroller body 15 are pivotably coupled to each other, in order that the stroller can be folded.

In this specification, the terms “front”, “rear”, “up”, “down”, “back to front direction”, “up and down direction” and “lateral direction” regarding the stroller 10 and the constituent elements of the stroller mean, unless otherwise specified, “front”, “rear”, “up”, “down”, “back to front direction” (or “back and front direction”), “up and down direction” and “lateral direction”, with respect to an operator who grasps the handle 40 to operate the stroller 10 in the unfolded condition, in particular, the foldable stroller 10 in the unfolded condition. More specifically, the “back to front direction” corresponds to a right and left direction on sheet planes of FIGS. 1 and 4. Unless otherwise specified, the “front” is a side to which the operator who pushes the handle faces. The right side of the sheet planes of FIGS. 1 and 4 is the front. Meanwhile, the “up and down direction” is a direction perpendicular to the back and front direction, and is a direction perpendicular to the ground on which the stroller 10 rests. Thus, when the ground surface is a horizontal surface, the “up and down direction” represents a vertical direction. The “lateral direction” is also a width direction, and is a direction perpendicular both to the “back to front direction” and the “up and down direction”.

The stroller 10 is described in more detail below with reference to FIGS. 1 to 4. The stroller 10 as a whole has a substantially symmetrical structure about a central surface in the width direction, which extends along the back to front direction. As can be understood from FIGS. 1 and 4, in the stroller 10 in this embodiment, the frame part 30 includes the pair of right and left front legs 31, the pair of right and left middle legs 34, the pair of right and left rear legs 37, a pair of right and left first link elements 41, a pair of right and left second link elements 42, a pair of right and left third link elements 43, a pair of right and left fourth link elements 44, a pair of right and left fifth link elements 45, a pair of right and left sixth link elements 46, and the handle 40. As can be well understood from FIGS. 1 to 3, the handle 40 has a U-shape, and includes a pair of right and left extending parts 40a and a connection part 40b extending between the pair of extending parts 40a.

As shown in FIG. 4, the first link element 41 is pivotably joined, at a rear portion thereof, in particular, a rear end of the rear portion in the illustrated example, to a lower portion of the corresponding extending part 40a of the handle 40, in particular, a lower end of the lower portion of the extending part 40a in the illustrated example. In addition, the first link element 41 is pivotably joined, at a front portion thereof, in particular, a front end of the front portion in the illustrated example, to an intermediate portion of the corresponding front leg 31. The second link element 42 is pivotably joined, at a lower portion thereof, in particular, a lower end of the lower portion in the illustrate example, to an intermediate portion of the corresponding first link element 41.

In the stroller 10 shown in FIGS. 1 to 4, the fourth link 44 functions as an armrest for a baby seated on the second seat unit 68. The fourth link element 44 is pivotably joined, at a rear portion thereof, in particular, a rear end of the rear portion in the illustrated example, to a lower portion or an intermediate portion of the corresponding extending part 40a of the handle 40. The position at which the fourth link element 44 is joined to the extending part 40a of the handle 40 is located above the position at which the first link element 41 is joined to the extending part 40a. In addition, the fourth link element 44 is pivotably joined, at a front portion thereof, in particular, a front end of the front portion in the illustrated example, to an upper portion of the corresponding second link element 42, in particular, an upper end of the upper portion of the second link element 42 in the illustrated example.

In the stroller 10 shown in FIGS. 1 to 4, the third link element 43 functions as an armrest for a baby seated on the first seat unit 66. The third link element 43 is pivotably joined, at a rear portion thereof, in particular a rear end of the rear portion in the illustrated example, to an intermediate portion or an upper portion of the corresponding second link element 42. The position at which the third link element 43 is joined to the second link element 42 is located between the position at which the second link element 42 and the fourth link element 44 are joined, and the position at which the second link element 42 and the first link element 41 are joined, in the longitudinal direction of the second link element 42.

The front leg 31 is pivotably joined, at an upper portion thereof, in particular, an upper end of the upper portion in the illustrated example, to a front portion of the corresponding third link element 42, in particular, a front end of the front portion of the third link element 43 in the illustrated example. The middle leg 34 is pivotably joined, at an upper portion thereof, in particular, an upper end of the upper portion in the illustrated example, to a front portion or an intermediate portion of the corresponding third link element 43. The position at which the middle leg 34 is joined to the third link element 43 is located between the position at which the third link element 43 and the second link element 42 are joined, and the position at which the third link element 43 and the front leg 31 are joined, in the longitudinal direction of the third link element 43.

The rear leg 37 is pivotably joined, at an upper portion thereof, in particular, an upper end of the upper portion in the illustrated example, to a front portion or an intermediate portion of the corresponding fourth link element 44. The position at which the rear leg 37 is joined to the fourth link element 44 is located between the position at which the fourth link element 44 and the extending part 40a of the handle 40 are joined, and the position at which the fourth link element 44 and the second link element 42 are joined, in the longitudinal direction of the fourth link element 44.

In addition, the frame part 30 includes the left fifth link element 45 connecting the left middle leg 34 and the left second link element 42, and the right fifth link element 45 connecting the right middle leg 34 and the right second link element 42. Each fifth link 45 is pivotably joined, at one portion thereof, to an intermediate portion of the middle leg 34, and is pivotably joined, at another portion thereof, to a lower portion or an intermediate portion of the second link element 42. The position at which the fifth link element 45 is joined to the second link element 42 is located between the position at which the second link element 42 and the first link element 41 are joined, and the position at which the second link element 42 and the third link element 43 are joined, in the longitudinal direction of the second link element 42. Namely, in the illustrated example, when the stroller 10 is viewed from the lateral side; a pivot axis line between the second link element 42 and the fifth link element 45 is displaced from both of a pivot axis line between the second link element 42 and the first link element 41 and a pivot axis line between the second link element 42 and the third link element 43.

Further, the frame part 30 includes the left sixth link element 46 connecting the left rear leg 37 and the left extending part 40a of the handle 40, and the right sixth link element 46 connecting the right rear leg 37 and the right extending part 40a of the handle 40. Each sixth link element 46 is pivotably joined, at one portion thereof, to an intermediate portion of the rear leg 37, and is pivotably joined, at another portion thereof, to a lower portion or an intermediate portion of the extending part 40a of the handle 40. The position at which the sixth link element 46 is joined to the extending part 40a of the handle 40 is located between the position at which the extending part 40a of the handle 40 and the first link element 41 are joined, and the position at which the extending part 40a of the handle 40 and the fourth link element 44 are joined, in the longitudinal direction of the extending part 40a of the handle 40. Namely, in the illustrate example, when the stroller 10 is viewed from the lateral side, a pivot axis line between the handle 40 and the sixth link element 46 is displaced from both of a pivot axis line between the handle 40 and the first link element 41 and a pivot axis line between the handle 40 and the fourth link element 44.

In addition, as shown in FIG. 1, there are provided, as members extending in the lateral direction (width direction) of the stroller 10, a first footrest connecting the pair of front legs 31, a second footrest 52 connecting the pair of middle legs 34, and a tray 50 connecting the pair of third link elements 43. Although not shown, a rear connecting member is disposed between the pair of rear legs 37, and a first support member for supporting the first seat unit 66 and a second support member for supporting the second seat unit 68 are disposed between the pair of first link elements 41.

The stroller body 15 is constituted by providing the wheel holding mechanisms 21, 24 and 27 holding wheels 22, 25 and 28 to the frame part 30 as structured above. In the illustrated example, the wheel holding mechanisms 21, 24 and 27 are fixed on lower ends of the corresponding legs 31, 34 and 37.

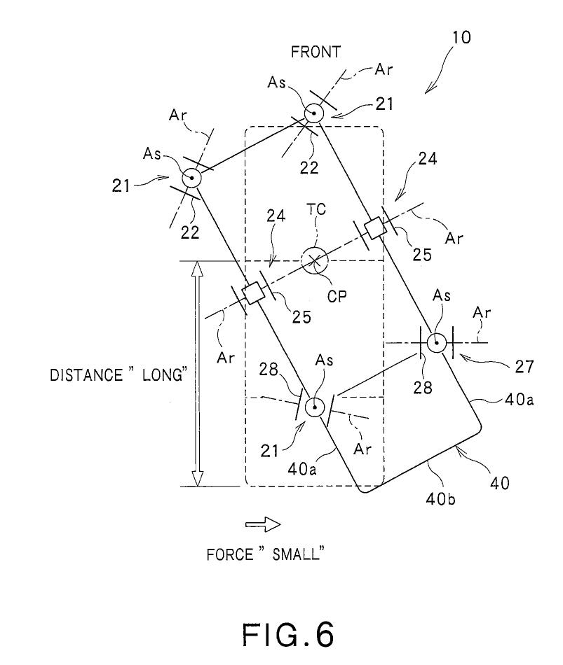

The front-wheel holding mechanism 21 provided on each front leg 31 is formed as a caster, and is configured to rotatably and turnably support the front wheel 22. Thus, as well shown in FIG. 6, the front wheel 22 of the front-wheel holding mechanism 21 is rotatable about a rotating axis line Ar and is turnable about a turning axis line As which is not in parallel with the rotating axis line Ar. When the front wheel 22 is turned about the turning axis line As, the front wheel 22 is extended in a direction at an angle with respect to the back to the front direction of the stroller 10, and the rotating axis line Ar of the front wheel 22 is extended in a direction at an angle with respect to the width direction of the stroller 10. Similarly, the rear-wheel holding mechanism 27 provided on each rear leg 37 is formed as a caster, and is configured to rotatably and turnably support the rear wheel 28. Thus, as well shown in FIG. 6, the rear wheel 28 of the rear-wheel holding mechanism 27 is rotatable about a rotating axis line Ar, and is turnable about a turning axis line As that is not in parallel with the rotating axis line Ar.

On the other hand, the middle-wheel holding mechanism 24 provided on each middle leg 34 is not formed as a caster. The middle-wheel holding mechanism 24 is configured to rotatably and unturnably support the middle wheel 25. Thus, as well shown in FIG. 6, the middle wheel 25 of the middle-wheel holding mechanism 24 is rotatable about an rotating axis line Ar. Meanwhile, the rotating axis line Ar of the middle wheel 25 is maintained in a constant direction. In the illustrate example, the rotating axis line Ar of the middle wheel 25 is extended in parallel with the width direction of the stroller 10.

The first seat unit 66 and the second seat unit 68 are mounted on the stroller body 15 as structured above. Preferably, the first seat unit 66 and the second seat unit 68 can be attached to and detached from the stroller body 15. The stroller 10 described herein is constituted as a tandem-type stroller for letting babies ride thereon in such a manner that the babies are seated in the back and front. Thus, the first seat unit 66 and the second seat unit 68 are arranged to be aligned in the back and front direction.

In the example shown in FIG. 4, when the stroller 10 is viewed from the lateral side, at least a portion of the first seat unit 66 is located between the front leg 31 and the middle leg 34, and at least a portion of the second seat unit 68, which is positioned rearward of the first seat unit 66, is located between the middle leg 34 and the rear leg 37. To be more specific, the first seat unit 66 and the second seat unit 68 respectively include seat parts 66a and 68a for supporting buttocks of babies, and back parts 66b and 68b facing backs of the babies.

The seat parts 66a and 68a of the respective seat units 66 and 68 are mainly supported by the pair of first link elements 41 and the first and second support members (not shown) provided on the pair of first link elements 41. As shown in FIG. 4, the seat part 68a of the second seat unit 68 is supported by a portion of the first link element 41, the portion being rearward of the position at which the first link element 41 is pivotably coupled to the second link element 42. The back part 68b of the second seat unit 68 is swingable with respect to the seat part 68a. For example, a reclining adjustment belt fixed to the pair of extending parts 40a of the handle 40 is disposed on a back side of the back part 68b of the second seat unit 68. By adjusting a length of the reclining adjustment belt, a reclining angle of the back part 68b can be adjusted.

On the other hand, the seat part 66a of the first seat unit 66 is supported by a front portion of the first link element 41, i.e., a portion of the first link element 41, the portion being substantially forward of the position at which the first link element 41 is pivotably coupled to the second link element 42. The back part 66b of the first seat unit 66 is swingable with respect to the seat part 66a. For example, a reclining adjustment belt fixed to the pair of second link elements 42 are disposed on a back side of the back part 66b of the first seat unit 66. By adjusting a length of the reclining adjustment belt, a reclining angle of the back part 66b can be adjusted.

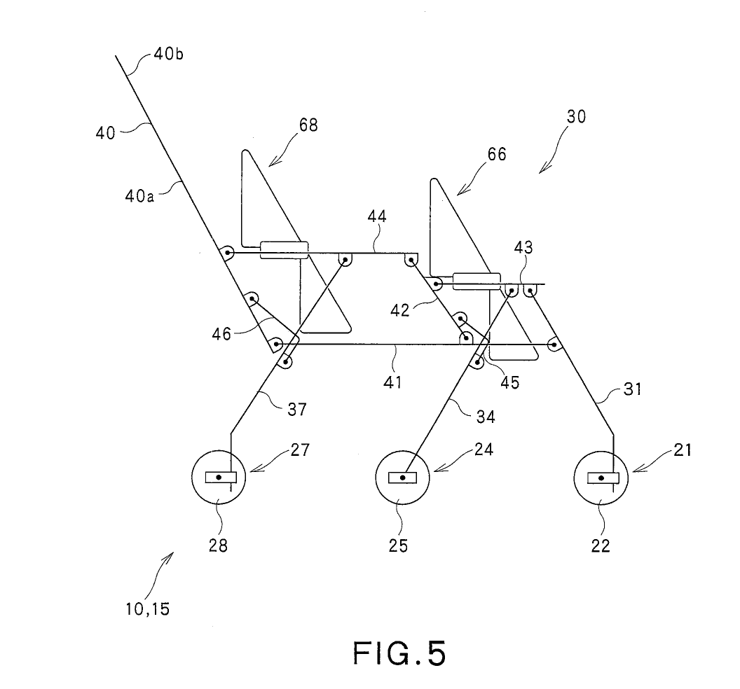

FIG. 5 shows a modification example of the first seat unit 66 and the second seat unit 68. In the modification example shown in FIG. 5, the first seat unit 66 is detachably attached to the third link element 43 of the stroller body 15. The second seat unit 68, which is positioned rearward of the first seat unit 66, is detachably attached to the fourth link element 44 of the stroller body 15. In this example, at least one of the first seat unit 66 and the second seat unit 68 can be attached to the stroller body 15, such that either a baby seated thereon faces forward (illustrated condition) and/or a baby seated thereon faces rearward.

As shown in FIG. 1, the stroller 10 further includes a front hood 61, a rear hood 62 and a basket 63, which are provided on the stroller body 15. The front hood 61 is disposed correspondingly to the first seat unit 66, and functions as a sun shade and a wind shade (protect from the wind) for a baby seated on the first seat unit 66. The rear hood 62 is disposed correspondingly to the second seat unit 68, and functions as a sun shad and a wind shade (protect from the wind) for a baby seated on the second seat unit 68. The basket 63 is disposed below the second seat unit 68. Illustration of the front hood 61, the rear hood 62 and the basket 63 is omitted in the drawings other than FIGS. 1 to 3.

The stroller 10 as structured above can be folded from the unfolded condition shown in FIG. 1 to the folded condition shown in FIG. 3 through the condition shown in FIG. 2. During the folding operation, the respective constituent elements forming the frame part 30 of the stroller body 15 are rotated (pivoted, swung) with each other about an axis line extending in the lateral direction.

The specific folding operation is as follows. Firstly, the handle 40 is once pulled up and then pushed down, so that the fourth link element 44 and the first link element 41 are rotated counterclockwise in FIGS. 1 and 2 with respect to the extending part 40a of the handle 40. Due to this operation, when the stroller 10 is viewed from the lateral side, the second link element 42 and the extending part 40a of the handle 40 are brought close to each other, in a substantially parallel relationship. In addition, the first link element 41 and the third link element 43 are rotated counterclockwise in FIGS. 1 and 2 with respect to the second link element 42. Due to this operation, when the stroller 10 is viewed from the lateral side, the second link element 42 and the front leg 31 are brought close to each other, in a substantially parallel relationship.

Further, during the folding operation, the middle leg 34 joined to the fifth link element 45 is rotated clockwise in FIGS. 1 and 2 with respect to the third link element 43. Similarly, the rear leg 37 joined to the sixth link element 46 is rotated clockwise in FIGS. 1 and 2 with respect to the fourth link element 44.

As shown in FIG. 3, as a result of the above folding operation, when the stroller 10 is viewed from the lateral side, the handle 40, the rear leg 37, the second ink element 42, the middle leg 34 and the front leg 31 are close to each other in substantially parallel with each other, with the handle 40 being located on a lower position. In the above manner, the stroller 10 can be folded, so that dimensions of the stroller 10 can be reduced along the back and front direction of the stroller 10 and along the up and down direction thereof. On the other hand, in order to unfold the stroller 10 in the folded condition shown in FIG. 3 to the unfolded condition shown in FIG. 1 through the condition shown in FIG. 2, the above folding steps are reversely performed.

As described above, a conventional stroller for letting babies ride thereon in such a manner that the babies are seated in the back to front direction has a problem of significantly poor steerability, which is caused by the long overall length of the stroller in the back to front direction. Such a problem of the conventional stroller is described with reference to FIG. 7. A conventional stroller 110 schematically illustrated in FIG. 7 includes a pair of front-wheel holding mechanisms 121 and a pair of rear-wheel holding mechanisms 127. The pair of front-wheel holding mechanisms 121 are formed as casters, and are configured to rotatably and turnably hold front wheels 122. The pair of rear-wheel holding mechanisms 127 are not formed as casters, and are configured to rotatably and unturnably hold rear wheels 128.

When such a stroller 110 travels along a curved path, namely, when such a stroller 110 turns, as shown in FIG. 7, the stroller 110 is turned about a turning center TC located near to the rear wheels in the back and front direction, so as to change a traveling direction of the stroller 110 from the traveling direction indicated by the dotted line in FIG. 7 to the traveling direction indicated by the solid line in FIG. 7, omitting a movement component in the back and front direction of the stroller 110. At this time, a steering person of the stroller 110 grasps a connection part 140a of a handle 140 and applies a force for changing the traveling direction of the stroller 110 along the width direction of the stroller 110.

However, a distance along the back to front direction of the stroller from the handle 140, to which the force for operation is added, to a turning center TC is short. On the other hand, the tandem-type stroller 10 has a large length in the back and front direction. Accordingly, a center position CP of a weight including a weight of the stroller itself and weights of babies seated on the stroller is distant away from the turning center TC along the back and front direction. In the first place, since a plurality of babies are placed on the tandem-type stroller 110, a large force is required for steering the stroller 110. As a result of the above, a larger force is required for turning the conventional stroller 110, which significantly impairs the steerability of the stroller 110.

In addition, as described above, since a large force is applied to the conventional stroller 110, it is necessary to make rigid the structural components of the stroller 110 including the handle 140. As a result, a total weight of the stroller 110 is increased, which further increases a force required for steering the stroller 110, resulting in further degradation in steerability of the stroller 110.

In order to eliminate such a problem, it can be considered that the length of the stroller 110 in the back to front direction is reduced. However, when the length of the stroller 110 in the back to front direction is reduced, livability or spaciousness in the stroller 110 is significantly degraded.

On the other hand, as described above, the stroller 10 in this embodiment further includes the middle legs 34, in addition to the front legs 31 and the rear legs 37. In addition, the stroller 10 includes the front-wheel holding mechanisms 21 provided on the front legs 31, which are formed as casters, the middle-wheel holding mechanisms 24 provided on the middle legs 34, which are not formed as casters, and the rear-wheel holding mechanisms 27 provided on the rear legs 37, which are formed as casters. Thus, when the stroller 10 is turned, as shown in FIG. 6, the stroller 10 is turned about a turning center TC located near to the middle wheels in the back and front direction, so as to change a traveling direction (facing direction) of the stroller 10 from the traveling direction indicated by the dotted line in FIG. 6 to the traveling direction indicated by the solid line in FIG. 6, omitting a movement component in the back and front direction of the stroller 10.

Thus, the distance of the stroller 10 along the back to front direction, from the connection part 40b of the handle 40, to which a steering person of the stroller 10 applies a force for steering the stroller 10, to the turning center TC can be elongated. Therefore, a force to be applied to the handle 40 for steering the stroller 10 can be significantly decreased. As a result, the steerability of the stroller 10 is significantly improved.

Furthermore, as shown in FIG. 4, when the stroller 10 is viewed from the front side, it is possible to locate the middle leg 34 and the middle-wheel holding mechanism 24 substantially between the first seat unit 66 and the second seat unit 68. In this case, a center position CP of a weight including the weight of the stroller itself and weights of babies on the stroller 10 can be located near to the middle wheel 25 in the back to front direction of the stroller 10. That is to say, as shown in FIG. 6, in the stroller 10 in this embodiment, the turning center TC about which the stroller 10 is turned so as to change a traveling direction of the stroller, and the center position CP of the weight of the stroller 10 can be located close to each other, and further the turning center TC and the center position CP can be at the same position in the back and front direction of the stroller 10. Thus, according to this embodiment, a moment required for changing a traveling direction of the stroller 10 can be significantly lowered.

Accordingly, a force to be applied to the handle 40 by a steering person when the stroller 10 is turned can be significantly effectively reduced. Thus, the steerability of the stroller 10 is significantly effectively improved. In addition, since a large force is not applied to the respective constituent elements of the stroller 10, the respective constituent elements can be simplified and reduced in weight. Thus, the steerability is further improved, as well as the manufacturing is the stroller 10 can be lowered. Furthermore, since it is not necessary to reduce the size of the stroller 10, in particular, the overall length thereof along the back to front direction, with a view of improvement in steerability, degradation in livability or spaciousness of the stroller 10 as well as comfortableness of the stroller 10 is avoided.

Moreover, in this embodiment, the tandem-type stroller 10 having a long overall length in the back to front direction is provided with, in addition to the front legs 31 and the rear legs 37, the middles legs 34 disposed between the front legs 31 and the rear legs 37. Thus, weights of babies on the stroller 10 is supported in a well balanced manner. In conjunction therewith, also in the foldable-type stroller 10 in which the respective constituent elements of the stroller 10 are rotatable with each other, deformation such as deflection of the stroller 10 can be effectively restrained. Also from these points, the steerability of the stroller 10 is effectively enhanced.

The aforementioned embodiment can be variously modified. An example of the modification will be described below.

For example, the detailed structures of the stroller 10 as described above are nothing more than mere examples. For example, the aforementioned embodiment shows the example in which there are provided the pair of front legs 31 located to be spaced apart from each other in the width direction, the pair of middle legs 34 located to be spaced apart from each other in the width direction, the pair of rear legs located to be spaced apart from each other in the width direction, the pair of first link elements 41 located to be spaced apart from each other in the width direction, the pair of second link elements 42 located to be spaced apart from each other in the width direction, the pair of third link elements 43 located to be spaced apart from each other in the width direction, the pair of fourth link elements 44 located to be spaced apart from each other in the width direction, the pair of fifth link elements 45 located to be spaced apart from each other in the width direction, and the pair of sixth link elements 46 located to be spaced apart from each other in the width direction. In this example, the front leg 31, the middle leg 34, the rear leg 37 and the first to sixth link elements 41 to 46, which are positioned on one side in the width direction (e.g., on the right side), are connected to each other so as to form a link structure for enabling the folding operation of the stroller body 15. Similarly, the front leg 31, the middle leg 34, the rear leg 37 and the first to sixth link elements 41 to 46, which are positioned on the other side in the width direction (e.g., on the left side) are connected to each other so as to form a link structure for enabling the folding operation of the stroller body 15. The front-wheel holding mechanism 22 including the front wheel 22 is disposed on each of the pair of front legs 31. The middle-wheel holding mechanism 24 including the middle wheel 25 is disposed on each of the pair of middle legs 34. The rear-wheel holding mechanism 27 including the rear wheel 28 is disposed on each of the pair of rear legs 37. However, not limited to this example, one of the pair of front legs 31, the pair of middle legs 34 and the pair of rear legs 37 may be formed in a U-shape, and the only one front-wheel holding mechanism 21, the only one middle-wheel holding mechanism 24 or the only one rear-wheel holding mechanism 27 may be provided.

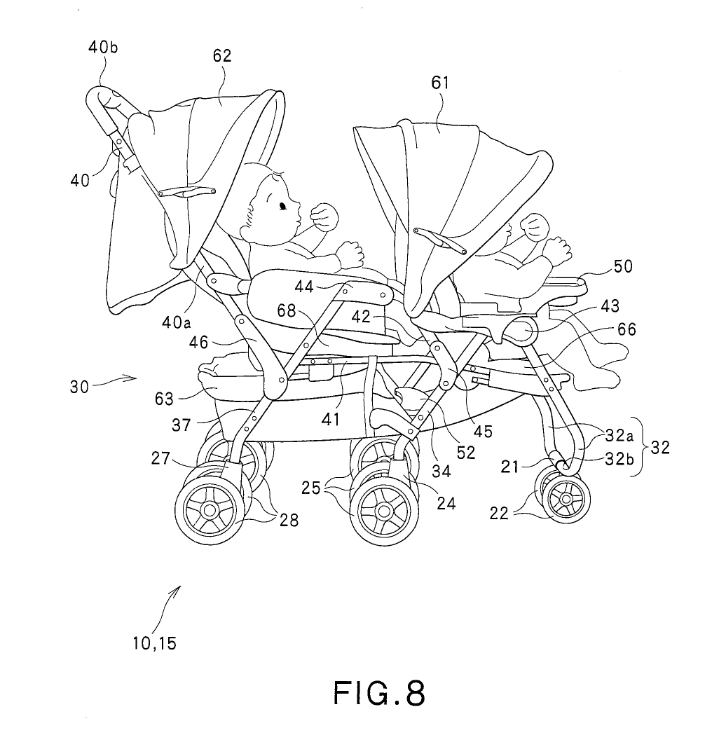

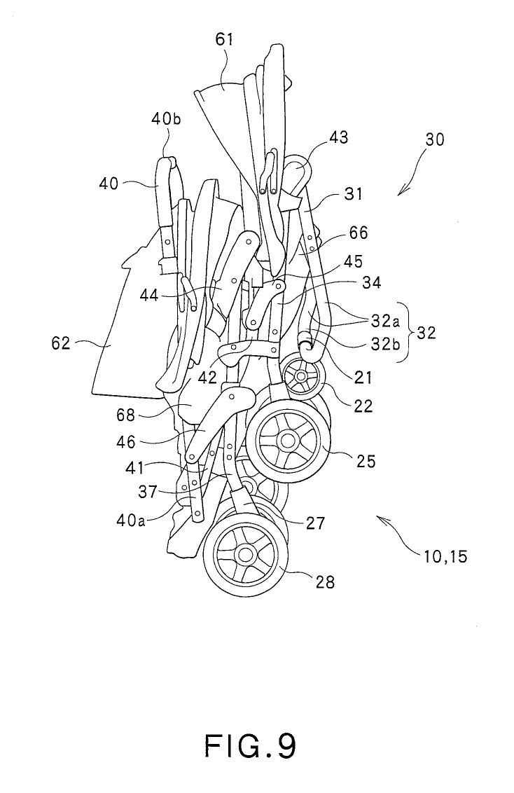

As an example, FIG. 8 shows that the front leg 32 includes a pair of extending parts 32a, and a connection part 32b connecting the pair of extending parts 32a. In the illustrated example, the connection part 32 extends between lower ends of the pair of extending parts 32a. In particular, in the example shown in FIG. 8, the front leg 32 is integrally formed in a U-shape. Such a front leg may be manufactured by, for example, bending a pipe made of metal such as aluminum alloy. Similarly to the front leg 31 in the aforementioned embodiment, each extending part 32a is joined to the first link element 41 and the third link element 43. On the other hand, the front-wheel holding mechanism 22 including the front wheel 21 is not disposed on each extending part 32a but disposed on the connection part 32b. Namely, the stroller 10 shown in FIG. 8 is a five-wheel stroller. Such a stroller 10 can provide the same effect as that of the aforementioned embodiment, as long as the front wheel 22 and the rear wheel 28 are rotatably and turnably held, while the middle wheel 25 is rotatably and unturnably held. Namely, it is possible to improve the steerability of a stroller capable of letting babies ride thereon in such a manner that the babies are seated in the back to front direction. By the same steps as those in the aforementioned embodiment, the stroller 10 can be folded, which is shown in FIG. 9, and the folded stroller 10 can be unfolded.

Further, not limited to the example shown in FIG. 8, the middle leg may be formed in a U-shape and the only one middle-wheel holding mechanism 24 holding the middle wheel 25 may be provided. Also in this embodiment, there can be provided the same effect as that of the aforementioned embodiment, as long as the front wheel 22 and the rear wheel 28 are rotatably and turnably held, while the middle wheel 25 is rotatably and unturnably held.

In addition, the detailed structures of the stroller 10 as described above are nothing more than mere examples. For example, although the stroller 10 in the above embodiment has the pair of front legs 31, the stroller 10 may have only one front leg 31. In this case, the number of the front-wheel holding mechanism 21 provided on the front leg 31 is one. Also in this modification example, the same effect as that of the above embodiment can be obtained.

Although some modification examples of the above embodiment are described, it is naturally possible to suitably combine the plurality of modification examples.

What is claimed is:

1. A stroller comprising:
a front leg;
a middle leg located rearward of the front leg;
a rear leg located rearward of the middle leg;
a front-wheel holding mechanism provided on the front leg, the front-wheel holding mechanism being configured to rotatably and turnably hold a front wheel;
a middle-wheel holding mechanism provided on the middle leg, the middle-wheel holding mechanism being configured to rotatably and unturnably hold a middle wheel; and
a rear-wheel holding mechanism provided on the rear leg, the rear-wheel holding mechanism being configured to rotatably and turnably hold a rear wheel,
wherein the stroller is capable of letting babies ride thereon in such a manner that the babies are seated in a back to front direction.

2. The stroller according to claim 1, further comprising:
a handle;
a first link element pivotably joined, at a rear portion thereof, to the handle, and pivotably joined, at a front portion thereof, to the front leg;
a second link element pivotably joined to a front portion of a fourth link element, and pivotably joined to an intermediate portion of the first link element;
a third link element pivotably joined, at a rear portion thereof, to the second link element, and pivotably joined to an upper portion of the front leg and an upper portion of the middle leg;
the fourth link element pivotably joined, at a rear portion thereof, to the handle, and pivotably joined to an upper portion of the rear leg;
a fifth link element pivotably joined to the second link element and the middle leg, respectively; and
a sixth link element pivotably joined to the handle and the rear leg, respectively.

3. The stroller according to claim 2, further comprising a first seat unit for letting a baby ride thereon and a second seat unit for letting a baby ride thereon,
wherein
the second seat unit is supported by a position, of the first link element, located rearward of the position at which the first link element is joined to the second link element, and
the first seat unit is supported by the first link element on a position that is forward of the second seat unit.

4. The stroller according to claim 2, further comprising a first seat unit for letting a baby ride thereon and a second seat unit for letting a baby ride thereon,
wherein
the first seat unit is supported by the third link element, and
the second seat unit is supported by the fourth link element.

5. The stroller according to claim 2, further comprising a first seat unit for letting a baby ride thereon and a second seat unit for letting a baby ride thereon,
wherein
at least a portion of the first seat unit is located between the front leg and the middle leg, in the back to front direction of the stroller, and
the second seat unit is located rearward of the first seat unit, and at least a portion of the second seat unit is located between the middle leg and the rear leg, in the back to front direction of the stroller.

6. The stroller according to any one of claim 1,
wherein:
a pair of the front legs are provided to be spaced apart from each other in a width direction;
a pair of the middle legs are provided to be spaced apart from each other in the width direction;
a pair of the rear legs are provided to be spaced apart from each other in the width direction;
the front-wheel holding mechanism is provided on each front leg;
the middle-wheel holding mechanism is provided on each middle leg; and
the rear-wheel holding mechanism is provided on each rear leg.

7. The stroller according to any one of claim 1,
wherein:
the front leg includes a pair of extending parts located to be spaced apart from each other in a width direction, and a connection part connecting the pair of extending parts;
a pair of the middle legs are provided to be spaced apart from each other in the width direction;
a pair of the rear legs are provided to be spaced apart from each other in the width direction;
the front-wheel holding mechanism is provided on the connection part;
the middle-wheel holding mechanism is provided on each middle leg; and
the rear-wheel holding mechanism is provided on each rear leg.

8. A stroller comprising:
a front leg;
a middle leg located rearward of the front leg;
a rear leg located rearward of the middle leg;
a first link element pivotably joined, at a front portion thereof, to the front leg;
a handle pivotably joined to a rear portion of the first link element;
a second link element pivotably joined to a front portion of a fourth link element, and pivotably joined to an intermediate portion of the first link element;
a third link element pivotably joined to a front portion of the fourth link element, and pivotably joined to an intermediate portion of the first link element;
the fourth link element pivotably joined, at a rear portion thereof, to the second link element, and pivotably joined to an upper portion of the front leg and an upper portion of the middle leg;
a fifth link element pivotably joined to the second link element and the middle leg, respectively; and
a sixth link element pivotably joined to the handle and the rear leg, respectively.

9. The stroller according to claim 8, further comprising a first seat unit for letting a baby ride thereon and a second seat unit for letting a baby ride thereon,
wherein
the second seat unit is supported by a position, of the first link element, located rearward of the position at which the first link element is joined to the second link element, and
the first seat unit is supported by the first link element on a position that is forward of the second seat unit.

10. The stroller according to claim 8, further comprising a first seat unit for letting a baby ride thereon and a second seat unit for letting a baby ride thereon,
wherein
the first seat unit is supported by the third link element, and
the second seat unit is supported by the fourth link element.

11. The stroller according to claim 8, further comprising a first seat unit for letting a baby ride thereon and a second seat unit for letting a baby ride thereon,
wherein
at least a portion of the first seat unit is located between the front leg and the middle leg, in the back to front direction of the stroller, and
the second seat unit is located rearward of the first seat unit, and at least a portion of the second seat unit is located between the middle leg and the rear leg, in the back to front direction of the stroller.

12. The stroller according to claim 8, wherein:
a pair of the front legs are provided to be spaced apart from each other in a width direction;
a pair of the middle legs are provided to be spaced apart from each other in the width direction; and
a pair of the rear legs are provided to be spaced apart from each other in the width direction.

13. The stroller according to claim 8, wherein:
the front leg includes a pair of extending parts located to be spaced apart from each other in a width direction, and a connection part connecting the pair of extending parts;
a pair of the middle legs are provided to be spaced apart from each other in the width direction; and
a pair of the rear legs are provided to be spaced apart from each other in the width direction.
